(19) United States
(12) Patent Application Publication
(10) Pub. No.: US 2024/0081328 A1
(43) Pub. Date: Mar. 14, 2024

(54) Use of 4-Nitro-3-(Trifluoromethyl)Phenol in Killing or Controlling Pomacea Canaliculata, Method for Killing or Controlling Pomacea Canaliculata, and Molluscicide

(71) Applicant: Jiangsu Institute of Parasitic Diseases, Wuxi, Jiangsu (CN)

(72) Inventors: Yuntian Xing, Wuxi, Jiangsu (CN); Jianrong Dai, Wuxi, Jiangsu (CN); Jun Cao, Wuxi, Jiangsu (CN); Jie Wang, Wuxi, Jiangsu (CN); Guoli Qu, Wuxi, Jiangsu (CN); Jiakai Yao, Wuxi, Jiangsu (CN); Yang Dai, Wuxi, Jiangsu (CN)

(21) Appl. No.: 18/248,561

(22) PCT Filed: Nov. 17, 2022
(86) PCT No.: PCT/CN2022/132419

§ 371 Date: Apr. 11, 2023

(30) Foreign Application Priority Data
Nov. 19, 2021 (CN) 202111398073.7

(51) Int. Cl. A01N 33/22; A01P 9/00

(52) U.S. Cl. CPC A01N 33/22; A01P 9/00

(57) ABSTRACT

The present disclosure relates to the technical field of alien invasive species control, in particular to use of 4-nitro-3-(trifluoromethyl)phenol in killing or controlling Pomacea canaliculata, a method for killing or controlling the Pomacea canaliculata, and a molluscicide. The present disclosure provides use of 4-nitro-3-(trifluoromethyl)phenol in killing or controlling Pomacea canaliculata. The 4-nitro-3-(trifluoromethyl)phenol can effectively control the Pomacea canaliculata with a low cost. In the present disclosure, the results of examples show that: the 4-nitro-3-(trifluoromethyl)phenol has an obvious killing effect on the Pomacea canaliculata, showing a control effect comparable to that of niclosamide, a commonly-used molluscicide for killing the Pomacea canaliculata.

### CROSS REFERENCE TO RELATED APPLICATION

The present application claims priority to the Chinese Patent Application No. CN202111398073.7, filed with the China National Intellectual Property Administration (CNIPA) on Nov. 19, 2021, and entitled “USE OF 4-NITRO-3-(TRIFLUOROMETHYL)PHENOL IN KILLING OR CONTROLLING POMACEA CANALICULATA, METHOD FOR KILLING OR CONTROLLING POMACEA CANALICULATA, AND MOLLUSCICIDE”, which is incorporated herein by reference in its entirety.

### TECHNICAL FIELD

The present disclosure relates to the technical field of alien invasive species control, in particular to use of 4-nitro-3-(trifluoromethyl)phenol in killing or controlling Pomacea canaliculata, a method for killing or controlling the Pomacea canaliculata, and a molluscicide.

### BACKGROUND

Pomacea canaliculata is native to the Amazon River Basin in South America. The Pomacea canaliculata was introduced to China in 1981 as an edible snail, and has become a highly harmful invasive alien species due to strong adaptability and rapid reproduction. Pomacea canaliculata has a large appetite, and destroys crop plants such as rice, causing serious production reduction as a veritable rice killer. In addition, the Pomacea canaliculata has a sharp shell that can easily scratch farmers' hands and feet, and excretes a large amount of feces to pollute the water body. Each Pomacea canaliculata lays about 10,000 eggs annually, showing an astonishing reproduction rate. The Pomacea canaliculata can cause the extinction of other aquatic species, thereby easily damaging the local wetland ecosystem and agricultural ecosystem.

### SUMMARY

The present disclosure provides use of 4-nitro-3-(trifluoromethyl)phenol in killing or controlling Pomacea canaliculata, a method for killing or controlling the Pomacea canaliculata, and a molluscicide. The 4-nitro-3-(trifluoromethyl)phenol can effectively control and even kill the Pomacea canaliculata.

The present disclosure provides the following technical solutions:

The present disclosure provides use of 4-nitro-3-(trifluoromethyl)phenol in killing or controlling Pomacea canaliculata.

The present disclosure provides a molluscicide for killing or controlling Pomacea canaliculata, where an active ingredient of the molluscicide includes 4-nitro-3-(trifluoromethyl)phenol.

Preferably, the molluscicide further includes an auxiliary material.

Preferably, the auxiliary material includes one or more of a film-forming agent, a surfactant, and a cosolvent.

Preferably, the film-forming agent includes methyl laurate and/or 2,2,4-trimethyl-1,3-pentanediol monoisobutyrate;
the surfactant includes alkylphenol ethoxylate (APEO); and
the cosolvent includes oleic acid.

Preferably, the auxiliary material includes the film-forming agent, the surfactant, and the cosolvent.

Preferably, the 4-nitro-3-(trifluoromethyl)phenol, the film-forming agent, the surfactant, and the cosolvent have a mass ratio of 5:30:4:61.

Preferably, when the film-forming agent includes the methyl laurate and the 2,2,4-trimethyl-1,3-pentanediol monoisobutyrate, the methyl laurate and the 2,2,4-trimethyl-1,3-pentanediol monoisobutyrate have a mass ratio of 25:5.

Preferably, a dosage form of the molluscicide includes a spreading oil.

The present disclosure further provides use of the molluscicide in killing or controlling Pomacea canaliculata.

The present disclosure further provides a method for killing or controlling Pomacea canaliculata, including the following steps:
applying the molluscicide into a water body

Preferably, the molluscicide is applied such that the active ingredient of the molluscicide in the water body has a concentration of 0.05 mg/L to 0.5 mg/L based on a volume of the water body.

Preferably, the Pomacea canaliculata is immersed in the molluscicide for 24 h to 72 h.

Preferably, the molluscicide is applied by spraying.

The present disclosure provides use of 4-nitro-3-(trifluoromethyl)phenol in killing or controlling Pomacea canaliculata. The 4-nitro-3-(trifluoromethyl)phenol can effectively control the Pomacea canaliculata. In the present disclosure, the results of examples show that: the 4-nitro-3-(trifluoromethyl)phenol has an obvious killing effect on the Pomacea canaliculata, showing a control effect comparable to that of niclosamide, a commonly-used molluscicide for killing the Pomacea canaliculata. Moreover, the 4-nitro-3-(trifluoromethyl)phenol has a price lower than that of the niclosamide, the commonly-used molluscicide for killing the Pomacea canaliculata, thus reducing a cost in controlling the Pomacea canaliculata. Therefore, the 4-nitro-3-(trifluoromethyl)phenol can be widely used in the field of Pomacea canaliculata control.

### DETAILED DESCRIPTION OF THE EMBODIMENTS

Unless otherwise specified, the components used in the present disclosure are all routinely purchased by those skilled in the art.

The present disclosure provides use of 4-nitro-3-(trifluoromethyl)phenol in killing or controlling Pomacea canaliculata. The 4-nitro-3-(trifluoromethyl)phenol can effectively control the Pomacea canaliculata with a low cost. In the present disclosure, the results of examples show that: the 4-nitro-3-(trifluoromethyl)phenol has an obvious killing effect on the Pomacea canaliculata, showing a control effect comparable to that of niclosamide, a commonly-used molluscicide for killing the Pomacea canaliculata.

In the present disclosure, the 4-nitro-3-(trifluoromethyl)phenol has a density of 1.554, a melting point of 76° C. to 79° C. (lit.), a boiling point of 135° C./0.01 mmHg to 138° C./0.01 mmHg (lit.), a flash point of 135° C./0.01 mm to 138° C./0.01 mm, and a refractive index of 1.507.

The present disclosure provides a molluscicide for killing or controlling Pomacea canaliculata, where an active ingredient of the molluscicide includes 4-nitro-3-(trifluoromethyl)phenol. In the present disclosure, the molluscicide further includes preferably an auxiliary material; and the auxiliary material includes preferably one or more of a film-forming agent, a surfactant, and a cosolvent. There is no special limitation on types of the film-forming agent, the surfactant, and the cosolvent, and those known to those skilled in the art can be used; in a specific example, the film-forming agent includes preferably methyl laurate and/or 2,2,4-trimethyl-1,3-pentanediol monoisobutyrate, more preferably the methyl laurate and the 2,2,4-trimethyl-1,3-pentanediol monoisobutyrate; the surfactant includes preferably APEO, more preferably the APEO; and the cosolvent includes preferably oleic acid, more preferably the oleic acid. A dosage form of the molluscicide includes preferably a spreading oil; and the spreading oil includes preferably the 4-nitro-3-(trifluoromethyl)phenol, the film-forming agent, the surfactant, and the cosolvent.

In the present disclosure, there is no special limitation on a preparation method of the spreading oil, which can be prepared in a manner known to those skilled in the art or by oneself. When a self-preparation method is adopted, the preparation method of the spreading oil includes preferably the following step: mixing the 4-nitro-3-(trifluoromethyl)phenol with the film-forming agent, the surfactant, and the cosolvent to obtain the spreading oil. The 4-nitro-3-(trifluoromethyl)phenol, the film-forming agent, the surfactant, and the cosolvent have a mass ratio of preferably 5:30:4:61; the film-forming agent includes preferably the methyl laurate and the 2,2,4-trimethyl-1,3-pentanediol monoisobutyrate; and the methyl laurate and the 2,2,4-trimethyl-1,3-pentanediol monoisobutyrate have a mass ratio of preferably 25:5.

The preparation method of the spreading oil includes preferably the following step: mixing the 4-nitro-3-(trifluoromethyl)phenol with the methyl laurate, the 2,2,4-trimethyl-1,3-pentanediol monoisobutyrate, the APEO, and the oleic acid sequentially to obtain the spreading oil. The spreading oil prepared by the preparation method can better exert a drug effect of the 4-nitro-3-(trifluoromethyl)phenol.

The present disclosure further provides use of the molluscicide in killing or controlling Pomacea canaliculata.

The present disclosure further provides a method for killing or controlling Pomacea canaliculata, including the following steps:
applying the molluscicide into a water body.

In the present disclosure, the molluscicide is applied such that the active ingredient 4-nitro-3-(trifluoromethyl)phenol of the molluscicide in the water body has a concentration of preferably 0.05 mg/L to 0.5 mg/L (for example, 0.05 mg to 0.5 mg of the 4-nitro-3-(trifluoromethyl)phenol is applied in 1 L of the water body; or 5 mg to 50 mg of the 4-nitro-3-(trifluoromethyl)phenol is applied in 100 L of the water body), more preferably 0.1 mg/L to 0.4 mg/L, and even more preferably 0.2 mg/L to 0.3 mg/L based on a volume of the water body; in a specific example, the active ingredient (4-nitro-3-(trifluoromethyl)phenol) of the molluscicide in the water body has a concentration of preferably 0.05 mg/L or 0.5 mg/L. The molluscicide is applied by spraying. The Pomacea canaliculata is immersed in the molluscicide for preferably 24 h to 72 h, more preferably 28 h to 68 h, even more preferably 32 h to 64 h, and most preferably 36 h to 60 h; in a specific example, the Pomacea canaliculata is immersed in the molluscicide for preferably 24 h, 48 h, or 72 h. In this way, Pomacea canaliculata can be killed, an impact on the production of fish ponds near the breeding environment of Pomacea canaliculata and other aquaculture economic areas can be reduced, and a risk of environmental pollution is lowered. The use of 4-nitro-3-(trifluoromethyl)phenol in killing or controlling Pomacea canaliculata, the method for killing or controlling the Pomacea canaliculata, and the molluscicide provided by the present disclosure are described in detail below in connection with examples, but these examples should not be understood as limiting the claimed scope of the present disclosure.

### Example 1

A preparation method of a spreading oil of 4-nitro-3-(trifluoromethyl)phenol with a mass percentage content of 5% included the following steps: 5 g of the 4-nitro-3-(trifluoromethyl)phenol was fully dissolved into 25 g of methyl laurate (as a film-forming agent), and 5 g of 2,2,4-trimethyl-1,3-pentanediol monoisobutyrate (as a film-forming agent), 4 g of APEO (as a surfactant), and 61 g of oleic acid (as a cosolvent) were added in sequence to obtain the spreading oil of 4-nitro-3-(trifluoromethyl)phenol with a mass percentage content of 5%.

### Use Example 1

An experiment was conducted in the paddy fields of Lujia Village, Zhenjiang City, Jiangsu Province, China, from Jul. 3 to 7, 2020. Each treated plot had an area of 10 m², a water depth of 20 cm, and a water volume of 2 m³, and was arranged in random blocks.

Before the test, Pomacea canaliculata was removed in all plots, and 50 Pomacea canaliculata samples were put in each plot. Before application, the field ridges should be repaired and the height of the field ridges should be increased to prevent water flow.

There were 3 treatments in total:
treatment 1 was: the spreading oil prepared in Example 1 was applied at a spraying concentration of 0.05 mg/L based on the active ingredient (4-nitro-3-(trifluoromethyl)phenol) in the spreading oil prepared in Example 1, that is, 0.05 mg of the 4-nitro-3-(trifluoromethyl)phenol was applied per liter of rice field water;
treatment 2 was: the spreading oil prepared in Example 1 was applied at a spraying concentration of 0.5 mg/L based on the active ingredient (4-nitro-3-(trifluoromethyl)phenol) in the spreading oil prepared in Example 1, that is, 0.5 mg of the 4-nitro-3-(trifluoromethyl)phenol was applied per liter of rice field water; and
treatment 3 was: a control group with clear water.

The number of dead snails and live snails was investigated 24 h, 48 h, and 72 h after spraying. The results of the investigation were shown in Table 1.

TABLE 1
Field test results of spreading oil of 4-nitro-3-(trifluoromethyl)phenol
in killing Pomacea canaliculata

| | Number of live | Number of live | Number of live |
|---|---|---|---|
| | snails 24 h | snails 48 h | snails 72 h |
| | after treatment | after treatment | after treatment |
| | (snails) | (snails) | (snails) |
| Treatment 1 | 48 | 21 | 10 |
| Treatment 2 | 0 | — | — |
| Control | 50 | 49 | 49 |
| group with | | | |
| clear water | | | |

From the data recorded in Table 1, it was seen that the molluscicide of the present disclosure could effectively kill and control Pomacea canaliculata.

### Use Example 2

0.5 mg of 4-nitro-3-(trifluoromethyl)phenol and 0.5 mg of niclosamide were completely dissolved in 1 mL of a dimethyl sulfoxide (DMSO) solution separately, and diluted to 1,000 mL with deaminized water to obtain a 4-nitro-3-(trifluoromethyl)phenol solution with a concentration of 0.5 mg/L and a niclosamide solution with a concentration of 0.5 mg/L.

The two solutions were separately diluted into 7 concentrations of dilutions using a doubling dilution method, including 0.25 mg/L, 0.125 mg/L, 0.0625 mg/L, 0.0312 mg/L, 0.0156 mg/L, and 0.0078 mg/L, and 0.0039 mg/L.

400 mL of the dilutions with different concentrations were separately poured into a 500 mL beaker, 10 Pomacea canaliculata samples were put into the dilution of each concentration, and each bottle mouth was sealed with wire mesh to completely immerse the Pomacea canaliculata in the dilution; clear water was used as a control group. The Pomacea canaliculata samples were placed in a constant-temperature incubator at (25±0.1)° C. with day and night alternation (light time for 12 h, dark time for 12 h); the survival number of Pomacea canaliculata at 12 h, 24 h, 36 h, 48 h, 60 h, and 72 h was investigated separately; if the blank control had a mortality rate of greater than 10%, the test needed to be repeated.

The experimental data were used to calculate the mortality rate of each treatment according to the following formula. Each calculation result was rounded to two decimal places. A formula for calculating the mortality rate was:

$$P = \frac{\sum Ki}{\sum Ni} \times 100.$$

In the formula: P represented the mortality rate, in percentage (%); Σ^{Ki} represented
the number of dead Pomacea canaliculata, in snails; Σ^{Ni} represented the total number of treated Pomacea canaliculata, in snails.

The specific killing conditions were shown in Table 2 and Table 3.

TABLE 2
Effects of different concentrations of 4-nitro-3-(trifluoromethyl)phenol
on killing Pomacea canaliculata

| | Mortality rate (%) of Pomacea canaliculata | | | | | | |
|---|---|---|---|---|---|---|---|
| Concentration | at different action time (h) | | | | | | |
| (mg/L) | 0 | 12 | 24 | 36 | 48 | 60 | 72 |
| 0.5 | 0 | 100 | 100 | 100 | 100 | 100 | 100 |
| 0.25 | 0 | 100 | 100 | 100 | 100 | 100 | 100 |
| 0.125 | 0 | 100 | 100 | 100 | 100 | 100 | 100 |
| 0.0625 | 0 | 70 | 100 | 100 | 100 | 100 | 100 |
| 0.0312 | 0 | 30 | 100 | 100 | 100 | 100 | 100 |
| 0.0156 | 0 | 10 | 100 | 100 | 100 | 100 | 100 |
| 0.0078 | 0 | 0 | 40 | 100 | 100 | 100 | 100 |
| 0.0039 | 0 | 0 | 20 | 50 | 50 | 50 | 70 |

TABLE 3
Effects of different concentrations of niclosamide
on killing Pomacea canaliculata

| | Mortality rate (%) of Pomacea canaliculata | | | | | | |
|---|---|---|---|---|---|---|---|
| Concentration | at different action time (h) | | | | | | |
| (mg/L) | 0 | 12 | 24 | 36 | 48 | 60 | 72 |
| 0.5 | 0 | 100 | 100 | 100 | 100 | 100 | 100 |
| 0.25 | 0 | 100 | 100 | 100 | 100 | 100 | 100 |
| 0.125 | 0 | 90 | 100 | 100 | 100 | 100 | 100 |
| 0.0625 | 0 | 30 | 50 | 80 | 80 | 100 | 100 |
| 0.0312 | 0 | 10 | 50 | 70 | 80 | 80 | 80 |
| 0.0156 | 0 | 10 | 30 | 60 | 70 | 70 | 70 |
| 0.0078 | 0 | 10 | 40 | 40 | 40 | 40 | 70 |
| 0.0039 | 0 | 0 | 20 | 30 | 30 | 30 | 40 |

From the records in Table 2 and Table 3, it was seen that for 4-nitro-3-(trifluoromethyl)phenol, at concentrations of 0.5 mg/L, 0.25 mg/L, and 0.125 mg/L and an action time of 12 h, the mortality rate of Pomacea canaliculata could reach 100%; a concentration of 0.0625 mg/L could kill all Pomacea canaliculata with an action time of 24 h. For niclosamide, the mortality rate of Pomacea canaliculata failed to reach 100% within 72 h at a concentration of below 0.0312 mg/L; when the concentration was 0.5 mg/L and 0.25 mg/L and the action time was 12 h, all Pomacea canaliculata died; and when the concentration was 0.125 mg/L, all Pomacea canaliculata died within 24 h. Experimental results show that the 4-nitro-3-(trifluoromethyl)phenol has a Pomacea canaliculata killing activity comparable to that of the niclosamide, showing application prospects.

The present disclosure has been disclosed with preferred examples as above, which shall not be construed as a limitation to the present disclosure. Any person skilled in the art can make changes and variations without departing from the spirit and scope of the present disclosure. The present disclosure shall fall within the protection scope defined in the claims.

1. A method for killing or controlling Pomacea canaliculata with 4-nitro-3-(trifluoromethyl)phenol.

2. A method for killing or controlling Pomacea canaliculata using a molluscicide, wherein an active ingredient of the molluscicide comprises 4-nitro-3-(trifluoromethyl)phenol.

3. The method according to claim 2, wherein the active ingredient of the molluscicide further comprises an auxiliary material.

4. The method according to claim 3, wherein the auxiliary material comprises one or more of a film-forming agent, a surfactant, and a cosolvent.

5. (canceled)

6. (canceled)

7. (canceled)

8. (canceled)

9. The method according to claim 2, wherein a dosage form of the molluscicide comprises a spreading oil.

10. (canceled)

11. A method for killing or controlling Pomacea canaliculata, comprising the following steps:
applying the molluscicide according to claim 2 into a water body.

12. The method according to claim 11, wherein the molluscicide is applied such that the active ingredient of the molluscicide in the water body has a concentration of 0.05 mg/L to 0.5 mg/L based on a volume of the water body.

13. The method according to claim 11, wherein the Pomacea canaliculata is immersed in the molluscicide for 24 h to 72 h.

14. The method according to claim 11, wherein the molluscicide is applied by spraying.

15. The method according to claim 11, wherein the active ingredient of the molluscicide further comprises an auxiliary material.

16. The method according to claim 15, wherein the auxiliary material comprises one or more of a film-forming agent, a surfactant, and a cosolvent.

17. (canceled)

18. (canceled)

19. (canceled)

20. The method according to claim 11, wherein a dosage form of the molluscicide comprises a spreading oil.

21. The method according to claim 12, wherein the molluscicide is applied such that the active ingredient of the molluscicide in the water body has a concentration of 0.125 mg/L to 0.25 mg/L based on the volume of the water body.

22. The method according to claim 13, the Pomacea canaliculata is immersed in the molluscicide for 48 h.
